(19) United States
(12) Patent Application Publication
(10) Pub. No.: US 2007/0208484 A1
(43) Pub. Date: Sep. 6, 2007

(54) Vehicle cruise control system and road condition estimating system

(75) Inventors: Tomohiro Tsujimura, Obu-city (JP); Ikurou Hasimoto, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/710,967

(22) Filed: Feb. 27, 2007

(30) Foreign Application Priority Data
Mar. 6, 2006 (JP) 2006-58909
Mar. 7, 2006 (JP) 2006-60430

(51) Int. Cl. B60T 8/72

(52) U.S. Cl. 701/93; 701/73

(57) ABSTRACT

An object of the invention is to provide a vehicle automatic running control system, according to which the vehicle automatic control operation is carried out as long as possible, even when the vehicle is running on a punishing road. For that purpose, the system of the invention determines a degree of concavity and convexity of a road surface and prohibits the automatic running control operation when the degree of concavity and convexity of the road surface is larger than a predetermined value.

### CROSS-REFERENCE TO RELATED APPLICATION

This application is based on Japanese Patent Application Nos. 2006-58909 filed on Mar. 6, 2006 and 2006-60430 filed on Mar. 7, 2006, disclosures of which are incorporated herein by reference.

### FIELD OF THE INVENTION

The present invention relates to a vehicle cruise control system, according to which a vehicle speed is automatically controlled during a cruise control operation. The present invention also relates to a road condition estimating system, according to which a degree of concavity and convexity of a road surface is estimated.

### BACKGROUND OF THE INVENTION

A cruise control system is conventionally known, according to which a vehicle speed is controlled at a preset target speed set by a vehicle driver (a constant speed control). Furthermore, as disclosed in Japanese Patent No. 3555450, such a cruise control system has been recently developed, in which a vehicle distance to a front vehicle is controlled at a constant distance and a vehicle speed is so controlled as to be changed to follow the front vehicle (a follow-up speed control).

According to the above cruise control system (the follow-up speed control), in which the vehicle speed is changed depending on that of the front vehicle, a coefficient of friction of a road surface is detected, so that the above follow-up speed control operation is stopped when the vehicle is running on such a road having a low coefficient of friction, on which a slip of the vehicle is likely to occur due to snow, ice, rain and so on.

A vehicle travel stability may be lost not only on the road surface having the low coefficient of friction but on a bumpy road. When the vehicle travels on the bumpy road having a large concavity and convexity, vertical vibration of the vehicle is increased. As a result, gripping force of a vehicle tire is decreased, so that the vehicle stability is lost and comfortable ride is deteriorated.

In another conventional vehicle cruise control system, a degree of concavity and convexity of a road surface is detected so that an electronic control suspension, an engine torque, or the like is controlled depending on the detected degree of the concavity and convexity of the road surface, for the purpose of improving vehicle travel stability as well as vehicle comfort ride.

The conventional technology for detecting the degree of the concavity and convexity of the road surface is, for example, disclosed in Japanese Patent Publication No. H5-201226. According to the conventional technology, a suspension sensor is provided for detecting a relative movement in the vertical direction between a vehicle wheel and a vehicle body (a movement of expansion and contraction of a suspension). A vehicle body acceleration sensor is further provided for detecting an acceleration of the vehicle body in the vertical direction. A load variation for the vehicle wheel (which corresponds to the degree of the concavity and convexity of the road surface) is detected based on the output signals from the suspension sensor and the vehicle body acceleration sensor.

According to the above structure, however, it is a problem in an increase of cost, since two different sensors (the suspension sensor and the vehicle body acceleration sensor) are necessary.

According to another prior art, such as Japanese Patent Publication No. 2005-104171, an acceleration sensor is provided for detecting the acceleration of a suspension device in the vertical direction in order to solve the above problem. Then, output signal of the acceleration sensor is processed through a filtering process to pick up acceleration compound of a specific frequency, to finally detect the degree of the concavity and convexity of the road surface.

According to the above method for detecting the concavity and convexity of the road surface by the filtering process of the output signal, as disclosed in the above Japanese Patent Publication No. 2005-104171, the output signals are largely varied depending on the vehicle speed, even when the degree of the concavity and convexity of the road surface is the same. Accordingly, it is difficult to constantly and precisely detect the degree of the concavity and convexity of the road surface, without receiving an influence of the vehicle speed. In particular, the detection itself of the concavity and convexity of the road surface would become impossible during a low speed running of the vehicle, because the output signal becomes smaller.

In addition, the concavity and convexity of the road surface may not be detected, unless the vehicle wheels run over the concavity and convexity of the road surface by several times and thereby the output signals of the acceleration sensor are largely vibrated by several times. This means that it is not possible to detect the concavity and convexity of the road surface in real time, namely there is a large delay in detection. The suspension control is carried out with delay, only after the influence by the concavity and convexity of the road surface has been appeared. As a result, a control characteristic with respect to the concavity and convexity of the road surface is not sufficiently high.

### SUMMARY OF THE INVENTION

The present invention is made in view of the above problems. An object of the present invention is, therefore, to provide a vehicle cruise control system, according to which an automatic running control operation can be carried out to an extent that the vehicle travel stability and comfort ride may not be deteriorated

It is another object of the present invention to provide a road condition estimating system, according to which the degree of the concavity and convexity of the road surface can be estimated with a smaller number of sensors to meet a requirement of cost down, and the degree of the concavity and convexity of the road surface can be precisely and quickly estimated without receiving the influence of the vehicle speed.

According to a feature of the present invention, a vehicle automatic running control system has a control portion for carrying out an automatic running control, in which a vehicle speed is automatically controlled, when a running mode is set to an automatic running control mode. The control system further has a determining portion for determining a degree of concavity and convexity of a road surface, on which the vehicle is running, and a prohibiting portion for prohibiting the automatic running control when the degree of concavity and convexity of the road surface is larger than a predetermined value.

According to another feature of the present invention, a road condition estimating system for a vehicle has a means for detecting a relative displacement between a vehicle wheel and a vehicle body or any other information related to the relative displacement. The system further has a means for estimating a vertical movement of the vehicle body by a movement model of the vehicle body, which simulates the vertical movement of the vehicle body depending on a vehicle running condition, and in which information for the vehicle running condition is inputted, and a means for estimating a degree of concavity and convexity of a road surface, based on a detected relative displacement between the vehicle wheel and the vehicle body and an estimated vertical movement of the vehicle body.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing a system structure of a vehicle cruise control system according to a first embodiment of the present invention;

FIG. 2 is a flow chart showing a routine for determining a vehicle automatic running operation;

FIG. 3 is a flow chart showing a routine for the vehicle automatic running operation;

FIGS. 4A to 4C are examples of maps for respectively calculating P gain “Kp”, I gain “Ki”, and D gain “Kd”;

FIG. 5 is a time chart for explaining the vehicle automatic running operation;

FIG. 6 is a schematic diagram showing a system structure of a vehicle cruise control system (a road condition estimating system) according to a second embodiment of the present invention;

FIG. 7 is a flow chart showing a routine for estimating the degree of the concavity and convexity of the road surface;

FIG. 8 is a flowchart showing a routine for renewing a movement model of a vehicle body; and

FIGS. 9A and 9B are time charts for respectively showing an example for a waveform of an input “u” to the movement model of the vehicle body and an example of an output “y” of the movement model of the vehicle body.

### DETAILED DESCRIPTION OF PREFERRED EMBODIMENTS

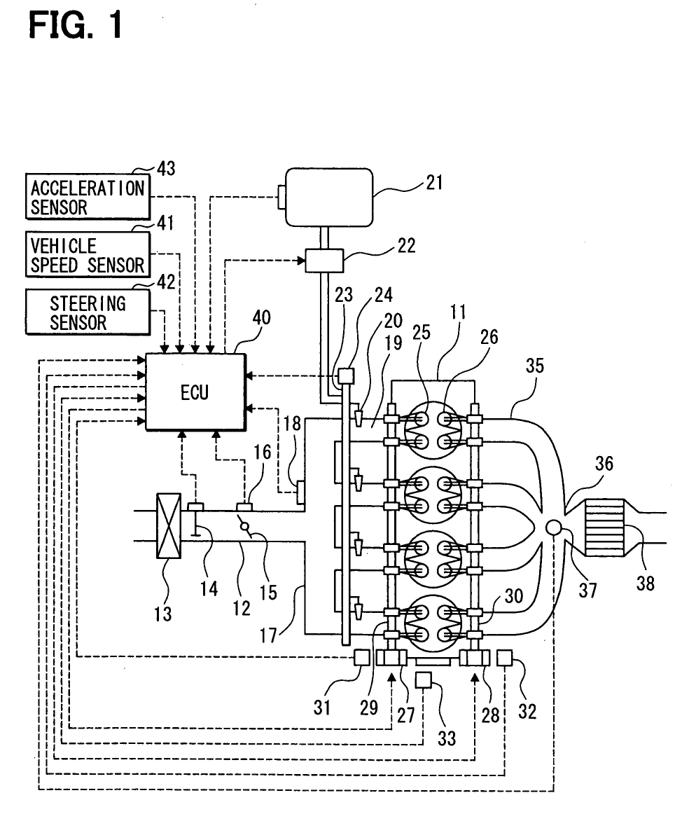

An embodiment of the present invention will be explained. A structure of an engine control system will be explained with reference to FIG. 1. An air cleaner 13 is provided at an upstream end of an air intake pipe 12 of an engine 11, which is, for example, a four cylinder in-line type internal combustion engine. An air-flow meter 14 is provided at a downstream side of the air cleaner 13, for detecting an amount of intake air to the engine 11. A throttle valve 15 and a throttle valve sensor 16 are provided at a downstream side of the air-flow meter 14, wherein an opening degree of the throttle valve 15 is controlled by an electric motor, and the sensor 16 detects the opening degree of the throttle valve 15.

A surge tank 17 is further provided at a downstream side of the throttle valve 15, and a pressure sensor 18 for detecting intake air pressure is provided at the surge tank 17. Multiple intake manifolds 19 are connected to the surge tank 17, for introducing the intake air into respective cylinders of the engine 11. A fuel injection valve 20 is provided adjacent to an intake port of the respective intake manifolds 19 for injecting fuel into the intake manifold. During an operation of the engine 11, fuel is supplied by a fuel pump 22 from a fuel tank 21 to a delivery pipe 23, so that the fuel is injected from the fuel injection valve 20 at fuel injection timing for the respective cylinders. A fuel pressure sensor 24 is provided in the delivery pipe 23 for detecting fuel pressure.

Variable valve timing devices 27 and 28 are provided in the engine 11 for respectively varying valve opening and valve closing timing for an intake valve 25 and for an exhaust valve 26. Furthermore, an intake cam angle sensor 31 and an exhaust cam angle sensor 32 are provided in the engine 11 for respectively outputting cam angle signals in synchronism with rotation of an intake cam shaft 29 and an exhaust cam shaft 30. A crank angle sensor 33 is provided in the engine 11 for outputting a crank angle signal of a pulse signal at each predetermined crank angle (for example, at each angle of 300) in synchronism with rotation of a crank shaft of the engine 11.

An air-fuel ratio sensor 37 for detecting air-fuel ratio of exhaust gas is provided at an exhaust gas collecting portion 36, at which exhaust manifolds 35 are collected. A catalyst 38, such as a three way catalyst for purifying CO, HC, NOx and so on contained in exhaust gas, is provided at a downstream side of the air-fuel ratio sensor 37.

In addition, a vehicle speed sensor 41 for detecting vehicle speed, a steering sensor 42 for detecting a steering angle of a steering wheel, an acceleration sensor 43 for outputting a signal for determining concavity and convexity of a road surface, are provided in the engine control system. The acceleration sensor 43 is arranged such that it detects vibration in the vertical direction of at least one of vehicle wheels.

The output signals from the above sensors are inputted to an engine control unit (ECU) 40, which generally includes a micro-computer to perform engine control programs memorized in the memory device (ROM), so that the opening degree of the throttle valve, the amount of fuel injected by the fuel injection valve 20, the ignition timing for the spark plug and so on are controlled in accordance with an engine operation condition.

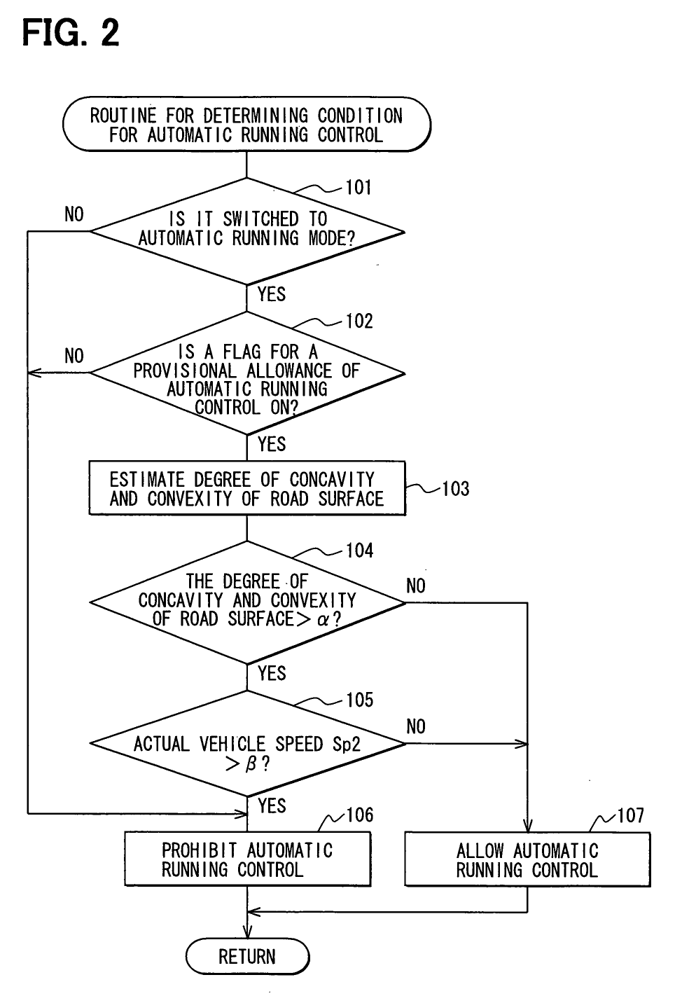

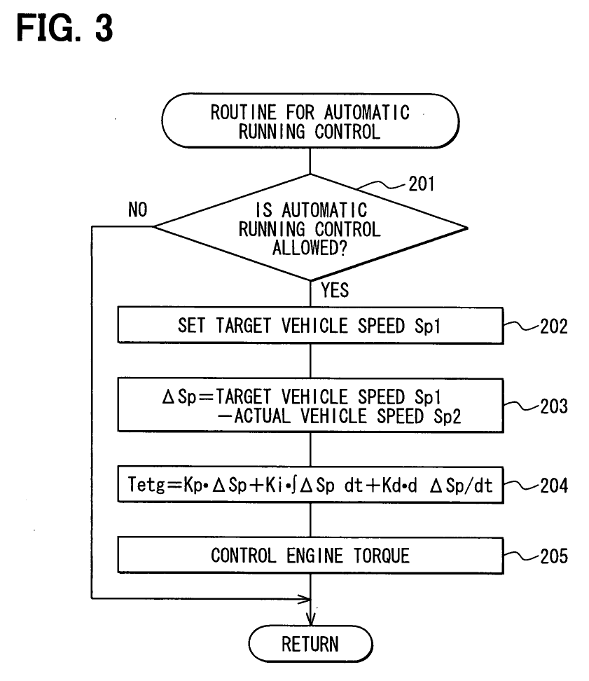

The ECU 40 carries out a routine shown in FIG. 2 for determining a condition of automatic running control, namely the ECU 40 allows or prohibits the automatic running control (i.e. the constant speed control or the follow-up speed control). When the automatic running control is allowed, the ECU 40 carries out a routine shown in FIG. 3 for the automatic running control operation. Hereinafter, the routines will be explained.

### (Routine for Determining Condition of Automatic Running Control)

The ECU 40 repeatedly carries out the process of the routine of FIG. 2, at a predetermined cycle during the engine operation.

At a step 101, the ECU 40 determines whether a vehicle running mode is switched, by a switching operation of a vehicle driver, to an automatic running mode, and the process goes to a step 106 to end with the routine by prohibiting the automatic running control, when the vehicle running mode is not switched to the automatic running mode.

On the other hand, when the ECU 40 determines that the vehicle running mode is switched to the automatic running mode, the process goes to a step 102 to determine whether a flag for a provisional allowance of the automatic running control is ON (namely, whether the automatic running control is provisionally allowed). The flag for the provisional allowance of the automatic running control is a flag for determining whether a vehicle condition is in a condition for carrying out the automatic running control. For example, the flag becomes ON, when all of the following conditions (1) to (3) are satisfied.
(1) Temperature of engine cooling water is higher than a predetermined temperature.
(2) Air-bags are not in operation.
(3) No malfunction is found out in the vehicle running control system, such as a throttle operation, a braking operation, an acceleration operation, and so on.

The ECU 40 determines that the vehicle condition is not in the condition for the automatic running control operation, when any one of the above three conditions (1) to (3) is not satisfied. The flag for the provisional allowance of the automatic running control is, therefore, made OFF (prohibited). And the process goes to the step 106 to end with the routine by prohibiting the automatic running control.

On the other hand, the ECU 40 determines that the vehicle condition is in the condition for the automatic running control operation, when all of the above three conditions (1) to (3) are satisfied. The flag for the provisional allowance of the automatic running control is, therefore, made ON (allowed). And the process goes to a step 103 to estimate a degree of the concavity and convexity of the road surface, based on the output signal from the acceleration sensor 43, which detects the vibration in the vertical direction of at least one of the vehicle wheels.

Then, the process goes on to a step 104, at which the ECU 40 determines whether the degree of the concavity and convexity of the road surface is larger than a predetermined value α. When the degree of the concavity and convexity of the road surface is smaller than the predetermined value α, the process goes to a step 107 to end with the routine by allowing the automatic running control.

When the ECU 40 determines at the step 104 that the degree of the concavity and convexity of the road surface is larger than the predetermined value α, the process goes to a step 105 to determine whether the actual vehicle speed Sp2 detected by the vehicle speed sensor 41 is higher than a predetermined vehicle speed β. When the actual vehicle speed Sp2 is lower than the predetermined vehicle speed β, the process goes to the step 107 to end with the routine by allowing the automatic running control. As above, the automatic running control operation is allowed so long as the actual vehicle speed Sp2 is lower than the predetermined vehicle speed β, even when the degree of the concavity and convexity of the road surface is larger than the predetermined value α.

When the ECU 40 determines at the step 105 that the actual vehicle speed Sp2 is higher than the predetermined vehicle speed β, the process goes to the step 106 to end with the routine by prohibiting the automatic running control. Accordingly, the automatic running control operation is prohibited, only when the degree of the concavity and convexity of the road surface is larger than the predetermined value α and the actual vehicle speed Sp2 is higher than the predetermined vehicle speed β.

The ECU 40 repeatedly carries out the process of the routine of FIG. 3, at a predetermined cycle during the engine operation.

At first, the ECU 40 determines at a step 201 whether the automatic running control operation is allowed or not. When it is not allowed, the ECU 40 ends with the routine without carrying out further steps.

On the other hand, when the ECU 40 determines at the step 201 that the automatic running control operation is allowed, the process goes to a step 202 to set a target vehicle speed Sp1. In case that the automatic running control is for the constant speed control, the target vehicle speed Sp1 is set by a switching operation of the vehicle driver. In case that the automatic running control is for the follow-up speed control, the target vehicle speed Sp1 is calculated based on a vehicle distance to the front vehicle as well as a vehicle speed of the front vehicle, wherein the target vehicle speed Sp1 is calculated as such a value with which the vehicle can follow the front vehicle while keeping the vehicle distance at a predetermined constant value.

Then, the process goes to a step 203 to calculate a deviation ΔSp (=Sp1−Sp2) between the target vehicle speed Sp1 and the actual vehicle speed Sp2 detected by the vehicle speed sensor 41. The ECU 40 calculates, at the following step 204, a target engine torque Tetg in accordance with the following formula through a PID control, so that the deviation ΔSp between the target vehicle speed Sp1 and the actual vehicle speed Sp2 will be made smaller.

Tetg=Kp·ΔSp+Ki··ΔSp·pdt+Kd·dΔSp/dt

wherein Kp is a proportional gain (P gain), Ki is an integration gain (I gain), and Kd is a differentiation gain (D gain).

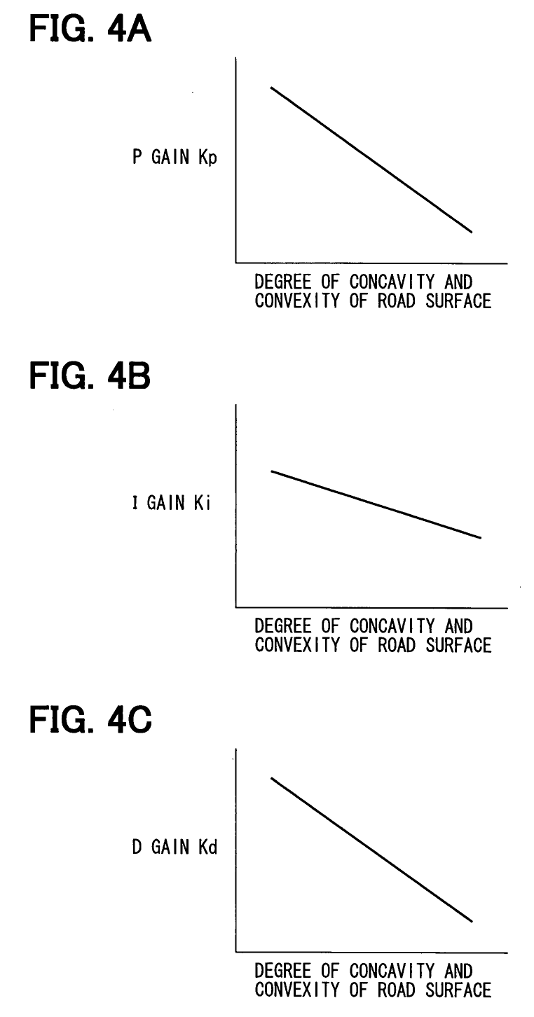

Respective constant values, which are in advance set in a process for an application work, may be used for the above control gains Kp, Ki, Kd. The control gains Kp, Ki, Kd may be, however, changed continuously or in a stepwise manner, based on maps as shown in FIGS. 4A to 4C, in accordance with the degree of the concavity and convexity of the road surface. In such a case, the respective control gains Kp, Ki, Kd may be preferably made smaller, as the degree of the concavity and convexity of the road surface becomes larger, so that a response for the follow-up control to the target vehicle speed Sp1 is delayed.

Then, the process goes on to a step 205 to carry out an engine torque control so that the actual vehicle speed Sp2 follows the target vehicle speed Sp1, wherein the opening degree of the throttle valve (the intake air amount), the ignition timing, the fuel injection amount, the valve timings, and so on are so controlled as to make generated engine torque at the engine 11 equal to the target engine torque Tetg.

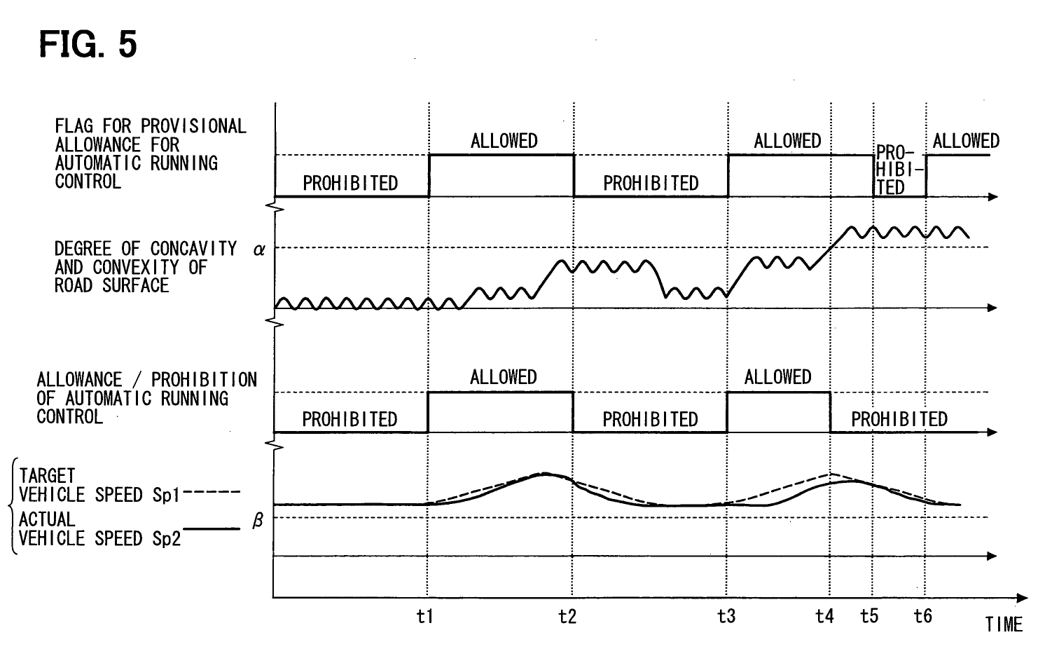

An example of the automatic running control (the follow-up speed control) according to the embodiment will be explained with reference to the time chart shown in FIG. 5.

At a time t1 of FIG. 5, the vehicle running mode is set by the switching operation of the vehicle driver to the automatic running control (the follow-up speed control), so that the flag for the provisional allowance of the automatic running control is switched to ON (allowed condition). As the degree of the concavity and convexity of the road surface is smaller than the predetermined value α at the time t1, the automatic running control is also allowed at the same time. As a result, the automatic running control (the follow-up speed control) is actually carried out.

The degree of the concavity and convexity of the road surface is smaller than the predetermined value α during a time period from the time t1 to the time t4. Accordingly, the actual allowance and prohibition for the automatic running control is simultaneously switched over in accordance with the switching-over of the flag for the provisional allowance of the automatic running control to the ON condition (allowed) or to the OFF condition (prohibited).

At a time t4, at which the degree of the concavity and convexity of the road surface becomes larger than the predetermined value α, the actual automatic running control is prohibited, even when the flag for the provisional allowance of the automatic running control is still ON (allowed). The condition for prohibiting the actual automatic running control continues at a time t5, at which the flag for the provisional allowance of the automatic running control is switched to OFF (prohibited). Furthermore, the condition for prohibiting the actual automatic running control continues even at a time t6, at which the flag for the provisional allowance of the automatic running control is switched to ON (allowed). This is because the degree of the concavity and convexity of the road surface is larger than the predetermined value α.

According to the above embodiment, the automatic running control is prohibited when the degree of the concavity and convexity of the road surface is larger than the predetermined value α. Therefore, the automatic running control operation is carried out to the extent, in which the vehicle travel stability as well as the vehicle comfort ride may not be deteriorated.

According to the above embodiment, the fact that the vehicle travel stability may not be largely affected if the actual vehicle speed Sp2 becomes lower, even when the degree of the concavity and convexity of the road surface becomes larger, is taken into consideration. Namely, the automatic running control is not prohibited during the actual vehicle speed Sp2 is lower than the predetermined vehicle speed β, even when the degree of the concavity and convexity of the road surface is larger than the predetermined value α. As a result, a range for the automatic running control, in which the vehicle travel stability can be realized, can be enlarged to the range of the lower vehicle speed.

Furthermore, the respective control gains Kp, Ki, and Kd for the PID control are made smaller as the degree of the concavity and convexity of the road surface becomes larger, as shown in FIGS. 4A to 4C, when calculating the target engine torque Tetg by the PID control so as to make the deviation ΔSp between the target vehicle speed Sp1 and the actual vehicle speed Sp2 smaller. Then, the response for the follow-up control to the target vehicle speed Sp1 is further delayed, as the degree of the concavity and convexity of the road surface becomes larger. Accordingly, a rapid acceleration or deceleration, which may otherwise adversely affect the vehicle travel stability and the vehicle comfort ride, can be avoided. Thus, the vehicle travel stability and the vehicle comfort ride can be improved, when the automatic running control is carried out on the road having the concavity and convexity.

The automatic running control is not limited to the PID control, but may be carried out by PI control, according to which the vehicle speed is controlled by the PI control.

As an alternative operation, the automatic running control may not be prohibited so long as a steering angle detected by the steering angle sensor 42 is lower than a predetermined value, even in the case that the degree of the concavity and convexity of the road surface is larger than the predetermined value α. This means that a degree of the decrease for the vehicle travel stability is smaller in case of the smaller steering angle, when compared with case of the larger steering angle, even when the degree of the concavity and convexity of the road surface is large.

Therefore, a range for the automatic running control, in which the vehicle travel stability can be realized, can be enlarged by not prohibiting the automatic running control when the steering angle is lower than the predetermined value.

In addition, the method for changing the control gains for the automatic running control depending on the degree of the concavity and convexity of the road surface can be applied independently from the degree of the concavity and convexity of the road surface.

According to the above embodiment, the degree of the concavity and convexity of the road surface is estimated based on the output signal from the acceleration sensor 43, which detects the vibration in the vertical direction of at least one of the vehicle wheels. However, the degree of the concavity and convexity of the road surface may be alternatively estimated in the following manner. A suspension sensor is provided for detecting an expansion and contraction amount (that is a displacement amount of a suspension arm) of a suspension device for the vehicle wheel in the vertical direction, or a vehicle height sensor is provided. An acceleration sensor is further provided for detecting vibration of the vehicle body in the vertical direction. Then, the degree of the concavity and convexity of the road surface is estimated based on a difference between the expansion and contraction amount of the suspension device and the vibration of the vehicle body in the vertical direction. Any other method for estimating the degree of the concavity and convexity of the road surface may be applied to the present invention.

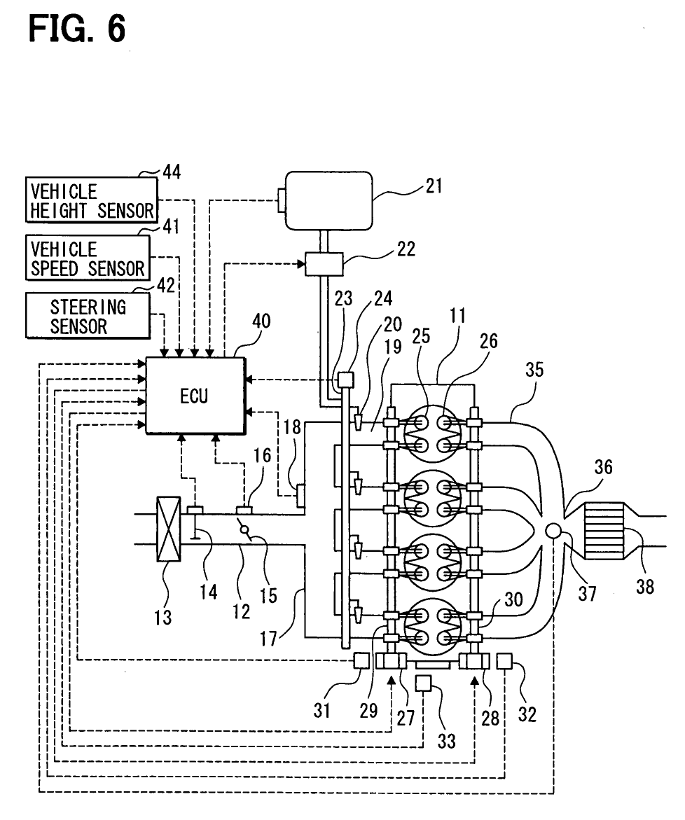

A second embodiment of the present invention will be explained with reference to FIGS. 6 to 9. A structure of an engine control system shown in FIG. 6 is similar to that shown in FIG. 1. The embodiment of FIG. 6 differs from the embodiment of FIG. 1 in that a vehicle height sensor 44 is provided in place of the acceleration sensor 43.

The vehicle height sensor 44 detects a relative displacement between the vehicle wheel and the vehicle body.

The vehicle height sensor 44 is provided in at least one of suspension devices for the vehicle wheels. Any kind of sensors can be applied to the vehicle height sensor 44, when the relative displacement between the vehicle wheel and the vehicle body in the vertical direction or any information related to the relative displacement can be detected in real time. For example, the relative movement of a suspension arm in the vertical direction to the vehicle body is converted into a rotational angle through a link mechanism connected between them, and a change of such rotational angle may be detected by an angular sensor. Alternatively, an ultrasonic sensor is provided at the vehicle body, so that the ultrasonic sensor is directed toward the road surface. The vehicle height is detected by projecting the ultrasonic wave to the road surface, and measuring propagation time until receiving the reflected ultrasonic wave from the road surface.

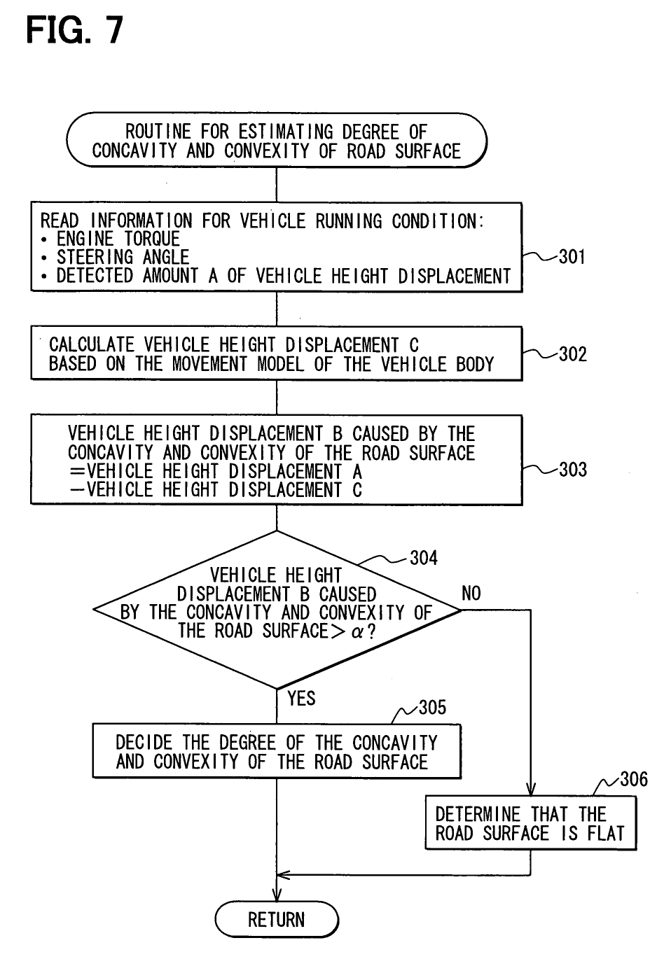

The ECU 40 carries out a routine of FIG. 7, as explained below, to estimate the degree of the concavity and convexity of the road surface based on the vehicle height displacement detected by the height sensor 44 and vehicle height displacement (suspension displacement) in the vertical direction estimated by the movement model for the vehicle body.

The movement model for the vehicle body is composed of an auto-regressive model (referred to as an AR model), wherein an engine torque is an input “u” and the vehicle height displacement (the suspension displacement) in the vertical direction caused by the engine torque is an output “y”. The engine torque is a typical information for vehicle running condition, wherein it causes the movement of the vehicle body in the vertical direction. The AR model is defined as below:

A(q)y(t)=B(q)u(t)

A(q)=1+a1q⁻¹+a2q⁻²+a3q⁻³+a4q⁻⁴+a5q⁻⁵+a6q⁻⁶

B(q)=b1q⁻¹+b2q²+b3q⁻³

In the above formula, q is a shift operator, and q⁻ⁿ designates the input “u” or the output “y” of the n times ago.

Accordingly, the A(q)y(t) and the B(q)u(t) can be expressed in the following manner:

A(q)y(t)=y(t)+a1y(t−1)+a2y(t−2)+a3y(t−3)+a4y(t−4)+a5y(t−5)+a6y(t−6)

B(q)u(t)=b1u(t−1)+b2u(t−2)+b3u(t−3)

Parameters a1 to a6 and b1 to b3 in the above movement model of the vehicle body are in advance decided by a process for a system identification, for example in a step of the application work. The movement model of the vehicle body is memorized in ROM or a re-writable and non-volatile memory of the ECU 40.

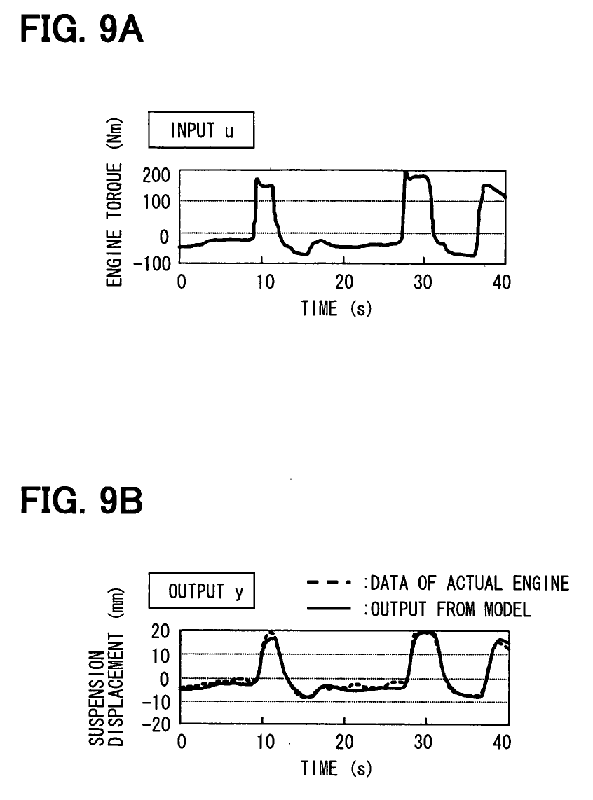

FIGS. 9A and 9B show time charts comparing data of an actual machine with the output from the model, when the engine torque is inputted to the movement model of the vehicle body and the vehicle height displacement (the suspension displacement) of the vehicle body in the vertical direction is calculated by the movement model of the vehicle body. The vehicle height displacement (the suspension displacement) of the vehicle body in the vertical direction, which is caused by the change of the engine torque during the acceleration or deceleration operation, can be precisely detected, when the movement model of the vehicle body is used and the engine torque is inputted as the input to the model.

In calculating the above vehicle height displacement by the movement model of the vehicle body, any one of engine torques (a demanded engine torque, a target engine torque, and an actual engine torque actually generated at the engine) may be used as the input. However, the demanded engine torque may be preferable in view of improving detection response. The demanded engine torque is calculated before the actual engine torque corresponding to the demanded engine torque is actually generated. It is, therefore, possible to estimate the movement of the vehicle body in the vertical direction which would be caused by the actual engine torque, even before the actual engine torque is generated, in the case that the demanded engine torque is applied to the movement model of the vehicle body to calculate the vehicle height displacement.

In a similar manner, a movement model (the auto-regressive model) for the vehicle body may be built up by a system identification process, such that the steering angle detected by the steering angle sensor 42 is inputted to the model and the vehicle height displacement (the suspension displacement) in the vertical direction caused by the steering angle is calculated. The movement model of the vehicle body is likewise memorized in ROM or the re-writable and non-volatile memory of the ECU 40, so that the vehicle height displacement (the suspension displacement) in the vertical direction caused by the steering angle may be estimated during the vehicle running. The vehicle height displacement during a vehicle turning operation can be more precisely estimated, when the vehicle height displacement is calculated with the input of the steering angle.

In case that the vehicle height displacement (the suspension displacement) in the vertical direction is estimated in consideration of the engine torque and the steering angle, the vehicle height displacement in the vertical direction estimated by the movement model for the vehicle body with the input of the engine torque may be added to the vehicle height displacement in the vertical direction estimated by the movement model for the vehicle body with the input of the steering angle. The above added value corresponds to the vehicle height displacement in the vertical direction, as a result that both of the engine torque and the steering angle are taken into consideration.

Furthermore, in addition to the engine torque and the steering angle, a brake pedal stroke (a braking force), a vehicle speed or the like is also one of information representing the vehicle running condition, which would cause the movement of the vehicle body in the vertical direction. Accordingly, a movement model of the vehicle body, in which the brake pedal stroke (the braking force), the vehicle speed or the like is used as the input, may be built up. And the vehicle height displacement in the vertical direction estimated by such movement model of the vehicle body may be further added to the above value, which is obtained as a result of considering both of the engine torque and the steering angle.

The vehicle height displacement A, which is generated when the vehicle runs over the concavity and convexity of the road surface during the vehicle running, is considered as an additional value (A=B+C) of the vehicle height displacement B generated by the concavity and convexity of the road surface and the vehicle height displacement C caused by the movement of the vehicle body in the vertical direction.

As a result of the above consideration, a difference (A−C) between the vehicle height displacement A detected by the vehicle height sensor 44 and the vehicle height displacement C estimated by the movement model of the vehicle body is calculated as the vehicle height displacement B, which is caused by the concavity and convexity of the road surface.

When the suspension device varies across the ages (aged deterioration), the movement of the vehicle body in the vertical direction (the vehicle height displacement) depending on the vehicle running condition is also varied. Therefore, when the aged deterioration further goes on, the accuracy of the movement model of the vehicle body is decreased, namely the estimation accuracy for the degree of the concavity and convexity of the road surface is decreased.

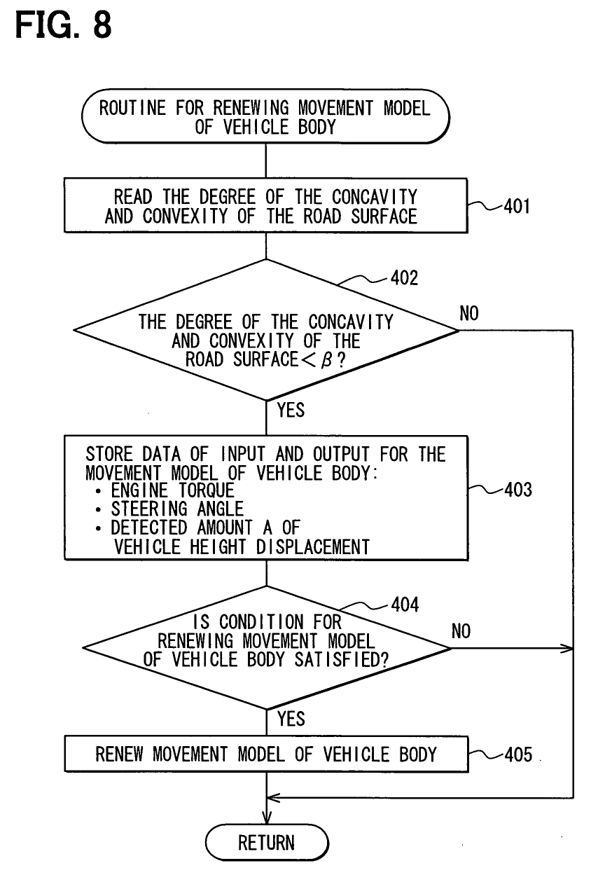

According to the above embodiment, the ECU 40 carries out a routine of FIG. 8 for renewing the movement model of the vehicle body in order to overcome the above problem (the problem caused by the aged deterioration).

According to the routine of FIG. 8, the data for the input and output of the movement model of the vehicle body are stored in the re-writable and non-volatile memory of the ECU 40, during a time period in which it is determined from the estimation for the degree of the concavity and convexity of the road surface that the vehicle is running on a flat road, namely in the time period in which the vehicle height displacement B caused by the concavity and convexity of the road surface can be regarded as almost zero. Then, the parameters a1 to a6 and b1 to b3 for the movement model of the vehicle body are renewed based on the above stored data. More detailed explanation for the routines of FIGS. 7 and 8 to be performed by the ECU 40 will be made below.

The ECU 40 repeatedly carries out the process of the routine of FIG. 7, at a predetermined cycle during the engine operation.

When the routine starts, the ECU 40 reads at a step 301 the engine torque (the demanded engine torque or the actual engine torque), which is the typical information for the vehicle running condition causing the movement of the vehicle body in the vertical direction, the steering angle detected by the steering angle sensor 42, and the vehicle height displacement A (the suspension displacement) detected by the suspension sensor 44.

Then, the process goes to a step 302, at which the ECU 40 calculates the vehicle height displacement C (the suspension displacement) caused by the acceleration/deceleration or the vehicle turning, by use of the movement model, wherein the engine torque and the steering angle are used as the inputs for the model.

The process further goes to a step 303, at which the ECU 40 calculates the difference (A−C) between the vehicle height displacement A detected by the vehicle height sensor 44 and the vehicle height displacement C estimated by the movement model of the vehicle body. The ECU 40 calculates the above difference (A−C) as the vehicle height displacement B caused by the concavity and convexity of the road surface.

The process goes to a step 304, at which the ECU 40 determines whether the vehicle height displacement B caused by the concavity and convexity of the road surface is larger than a predetermined value α. The process goes to a step 306, when the ECU 40 determines that the vehicle height displacement B caused by the concavity and convexity of the road surface is smaller than the predetermined value α. Namely, the ECU 40 determines that the vehicle is running on the flat road having almost no concavity and convexity. On the other hand, the process goes to a step 305, when the ECU 40 determines at the step 304 that the vehicle height displacement B caused by the concavity and convexity of the road surface is larger than the predetermined value α. And the ECU 40 decides the degree of the concavity and convexity of the road surface from the vehicle height displacement B caused by the concavity and convexity of the road surface.

The information for the degree of the concavity and convexity of the road surface, which is estimated as above, can be used for the suspension control system, the engine torque control system, the anti-brake skid control system, the traction control system, the cruise control system, and so on.

The ECU 40 repeatedly carries out the process of the routine of FIG. 8, at a predetermined cycle during the engine operation.

When the routine starts, the ECU 40 reads at a step 401 the degree of the concavity and convexity of the road surface, which is calculated according to the routine of FIG. 7. At a step 402, the ECU 40 determines whether the degree of the concavity and convexity of the road surface is smaller than a predetermined value β. The ECU 40 determines that the road condition is bad (the punishing road) when the ECU 40 determines that the degree of the concavity and convexity of the road surface is larger than the predetermined value β. In such a case, the routine of FIG. 8 is terminated without carrying out any further steps.

On the other hand, the ECU 40 determines that the vehicle is running on the flat road, when the ECU 40 determines at the step 402 that the degree of the concavity and convexity of the road surface is smaller than the predetermined value β. Then, the process goes to a step 403 to store the current data for the inputs (the engine torque, the steering angle) to and the current data for the outputs from the movement model of the vehicle body, and the vehicle height displacement A detected by the vehicle height sensor 44, in the re-writable and non-volatile memory of the ECU 40.

The process further goes to a step 404, at which the ECU 40 determines whether a renewal condition for the movement model of the vehicle body is satisfied or not, for example, based on the following conditions (1) and (2):

(1) whether the data necessary for the identification of the parameters a1 to a6 and b1 to b3 for the movement model of the vehicle body are stored in the non-volatile memory; and

(2) whether the current process is more than a predetermined period (a predetermined number of vehicle travels, a predetermined number of miles) from the previous renewal of the movement model of the vehicle body.

In the case that either one of the above conditions (1) and (2) is not satisfied, the condition for renewing the movement model of the vehicle body is not satisfied, and therefore the routine is terminated.

On the other hand, when both of the above conditions are satisfied, the condition for renewing the movement model of the vehicle body is satisfied. Therefore, the process goes to a step 405 to renew the parameters a1 to a6 and b1 to b3 for the movement model of the vehicle body by the method of the system identification, based on the data stored in the non-volatile memory.

According to the above embodiment, the movement model of the vehicle body is used to calculate the vehicle height displacement due to the movement of the vehicle body in the vertical direction, wherein the engine torque and the steering angle (which are typical information for the vehicle running condition causing the vertical movement of the vehicle body) are inputted to the movement model. Then, the vehicle height displacement generated by the concavity and convexity of the road surface is calculated from the vehicle height displacement obtained by the above movement model of the vehicle body and the vehicle height displacement detected by the vehicle height sensor 44. As a result, the acceleration sensor for the vehicle body, which was necessary in the prior art for detecting the degree of the concavity and convexity of the road surface, is no longer necessary according to the invention, so that the number of sensors is reduced to meet the requirement of the cost reduction.

In addition, the vehicle height displacement detected by the vehicle height sensor 44 is the information detected in real time without being influenced by the vehicle speed. In the same manner, the vertical movement of the vehicle body estimated by the movement model based on the engine torque and the steering angle is likewise the information estimated in real time without being influenced by the vehicle speed. This means that the vehicle height displacement generated by the concavity and convexity of the road surface can be estimated in real time without being influenced by the vehicle speed, based on the above detected amount by the vehicle height sensor 44 and the calculated amount by the movement model of the vehicle body.

As above, the system for estimating the degree of the concavity and convexity of the road surface according to the embodiment can accurately detect the degree of the concavity and convexity of the road surface without being influenced by the vehicle speed, while the system of the present embodiment realizes the reduction in the number of sensors to meet the requirement of reducing the cost.

Furthermore, according to the above embodiment, the data for the input and output of the movement model of the vehicle body are stored in the re-writable and non-volatile memory, during the time period in which the ECU determines based on the estimation for the degree of the concavity and convexity of the road surface that the vehicle is running on the flat road, namely in the time period in which the vehicle height displacement B caused by the concavity and convexity of the road surface can be regarded as almost zero. And the parameters for the movement model of the vehicle body are renewed based on the above stored data.

Accordingly, the parameters for the movement model of the vehicle body can be timely renewed, depending on the aged deterioration of the suspension device in which the characteristic of the vertical movement of the vehicle body is changed. Namely, it is possible to prevent the decrease in the estimating accuracy for estimating the degree of the concavity and convexity of the road surface, which may be otherwise caused by the aged deterioration of the suspension device.

What is claimed is:

1. A vehicle automatic running control system comprising:
a control portion for carrying out an automatic running control, in which a vehicle speed is automatically controlled, when a running mode is set to an automatic running control mode;
a determining portion for determining a degree of concavity and convexity of a road surface, on which the vehicle is running; and
a prohibiting portion for prohibiting the automatic running control when the degree of concavity and convexity of the road surface is larger than a predetermined value.

2. A vehicle automatic running control system according to claim 1, further comprising:
a vehicle speed sensor for detecting a vehicle speed,
wherein the prohibiting portion does not prohibit the automatic running control even when the degree of concavity and convexity of the road surface is larger than the predetermined value, if the vehicle speed detected by the vehicle speed sensor is lower than a predetermined value.

3. A vehicle automatic running control system according to claim 1, further comprising:
a steering angle sensor for detecting a steering angle,
wherein the prohibiting portion does not prohibit the automatic running control even when the degree of concavity and convexity of the road surface is larger than the predetermined value, if the steering angle detected by the steering angle sensor is lower than a predetermined value.

4. A vehicle automatic running control system according to claim 1, further comprising:
a control gain varying portion for changing control gains for the automatic running control depending on the degree of the concavity and convexity of the road surface.

5. A vehicle automatic running control system comprising:
a control portion for carrying out an automatic running control, in which a vehicle speed is automatically controlled, when a running mode is set to an automatic running control mode;
a determining portion for determining a degree of concavity and convexity of a road surface, on which the vehicle is running; and
a gain varying portion for changing control gains for the automatic running control depending on the degree of the concavity and convexity of the road surface determined by the determining portion.

6. A vehicle automatic running control system according to claim 1, wherein
the determining portion for determining the degree of concavity and convexity of the road surface comprises;
a means for detecting a relative displacement between a vehicle wheel and a vehicle body or any other information related to the relative displacement;
a means for estimating a vertical movement of the vehicle body by a movement model of the vehicle body, which simulates the vertical movement of the vehicle body depending on a vehicle running condition, and in which information for the vehicle running condition is inputted; and
a means for estimating the degree of concavity and convexity of the road surface, based on a detected relative displacement between the vehicle wheel and the vehicle body and an estimated vertical movement of the vehicle body.

7. A vehicle automatic running control system according to claim 5, wherein
the determining portion for determining the degree of concavity and convexity of the road surface comprises;
a means for detecting a relative displacement between a vehicle wheel and a vehicle body or any other information related to the relative displacement;
a means for estimating a vertical movement of the vehicle body by a movement model of the vehicle body, which simulates the vertical movement of the vehicle body depending on a vehicle running condition, and in which information for the vehicle running condition is inputted; and
a means for estimating the degree of concavity and convexity of the road surface, based on a detected relative displacement between the vehicle wheel and the vehicle body and an estimated vertical movement of the vehicle body.

8. A road condition estimating system for a vehicle comprising:
a means for detecting a relative displacement between a vehicle wheel and a vehicle body or any other information related to the relative displacement;
a means for estimating a vertical movement of the vehicle body by a movement model of the vehicle body, which simulates the vertical movement of the vehicle body depending on a vehicle running condition, and in which information for the vehicle running condition is inputted; and
a means for estimating a degree of concavity and convexity of a road surface, based on a detected relative displacement between the vehicle wheel and the vehicle body and an estimated vertical movement of the vehicle body.

9. A road condition estimating system according to claim 8, wherein
information of engine torque is inputted to the movement model of the vehicle body as one of the information for the vehicle running condition, and
the movement model of the vehicle body outputs an estimated amount of the vertical movement of the vehicle body, which is caused by the vehicle running condition identified by the inputted information.

10. A road condition estimating system according to claim 8, wherein
information of a steering angle is inputted to the movement model of the vehicle body as one of the information for the vehicle running condition, and
the movement model of the vehicle body outputs an estimated amount of the vertical movement of the vehicle body, which is caused by the vehicle running condition identified by the inputted information.

11. A road condition estimating system according to claim 9, wherein
the degree of concavity and convexity of the road surface is estimated based on a difference between the detected relative displacement between the vehicle wheel and the vehicle body and the estimated amount of the vertical movement of the vehicle body.

12. A road condition estimating system according to claim 8, further comprising:
a means for storing data for input and output of the movement model of the vehicle body in a re-writable and non-volatile memory, during a time period in which it is determined from the estimation for the degree of the concavity and convexity of the road surface that the vehicle is running on a flat road, and
a means for renewing the parameters for the movement model of the vehicle body based on the stored data.
